(19) United States
(12) Patent Application Publication
(10) Pub. No.: US 2025/0084887 A1
(43) Pub. Date: Mar. 13, 2025

(54) Fastening Clip

(71) Applicant: Illinois Tool Works Inc., Glenview, IL (US)

(72) Inventor: Victor DÍEZ HERRERA, Sabadell (ES)

(21) Appl. No.: 18/830,009

(22) Filed: Sep. 10, 2024

(30) Foreign Application Priority Data
Sep. 11, 2023 (GB) 2313812.6

(51) Int. Cl. F16B 21/07; B60R 21/20

(52) U.S. Cl. CPC F16B 21/075; B60R 21/20

(57) ABSTRACT

Disclosed is a fastening clip (100) for mounting in a hole of a component. The fastening clip includes a clip body (102) having a first end (104), a second end (106) and a pair of side walls (108) extending from the first end to the second end and defining an internal cavity (126) of the clip body. Each side wall is provided with a window (110). The fastening clip also includes a pair of retaining portions (112) extending from the side walls at the second end of the clip body. Each of the retaining portions includes a protruding portion (113) that protrudes through the window in the respective side wall and is deflectable into the internal cavity of the clip body when the fastening clip is mounted through the hole of the component, and an end portion (128) provided within the internal cavity of the clip body. The fastening clip (100) also includes a head portion (114) provided at the first end of the clip body and protruding from the side walls. Each of the pair of side walls includes a protuberance (136) protruding into the internal cavity, and the protuberance maintains a separation between the end portion of the retaining portion and the side wall for insertion of a removal tool between the end portion of the retaining portion and the side wall to deflect the retaining portion inwards for removal of the fastening clip from the component.

### RELATED APPLICATIONS

The present application claims the benefit of British Patent Application No. 2313812.6, filed Sep. 11, 2023, titled “Fastening Clip,” the contents of which are hereby incorporated by reference.

### BACKGROUND

Airbags are safety devices used in the motor industry and which, in combination with other safety components, such as seatbelts, help to reduce fatal accidents in the case of collisions. The tests to which the vehicles have been subjected, as well as mortality statistics, have clearly demonstrated that the use of airbags can considerably improve the safety of automobile occupants and, when combined with other forms of passive safety, such as seat belts, significantly reduce mortality in the case of serious accidents.

Today, manufacturers produce frontal airbags, which are designed to protect the driver and/or passenger in the event of a head-on collision and, considering their positions, lateral airbags that are installed behind the posts and/or in the sides of the vehicle seats, along with curtain airbags.

Airbags of the curtain type are usually located in the part close to the roof on the sides of the automobile, e.g. situated above the front and rear doors. Such airbags have very rigorous requirements with regards to the goals set for them and the technical challenges that have to be overcome. Typical challenges may be their location in the vehicle and the way they are fastened, required deployment time and the time that the airbag is required to remain inflated. Other challenges may come from the fact that there is only a short distance between the body and the occupant and that there is little vehicle material between the occupant and an impacting vehicle. For example, it is essential that airbags are deployed in a fraction of a second, giving rise to an enormous snatch force on their attachment components, which then suffer the consequences of that impact.

Further, when installing new or restoring previously deployed airbags, it is well known in the industry that the installation or restoration is tedious work, comprising steps, such as, (i) dismantling all the attachments of the airbag, (ii) replacing the airbag and installing a new one, and then again (iii) fitting all its attachments. The work involved generally requires the installer to at least partly manually assemble the clip components with the airbag and push the assembly into a vehicle panel or structure to attach or operably couple the airbag to the vehicle.

### SUMMARY

The present disclosure relates generally to a fastener, substantially as illustrated by and described in connection with at least one of the figures, as set forth more completely in the claims. In one example, the disclosure generally relates to the field of fasteners and in particular, to the field of fastening clips for attaching one or more components, such as airbag devices, to an external structure. More specifically, the present disclosure relates to a fastening clip and a fastening clip assembly for attaching a side-impact airbag or curtain-type airbag to a vehicle structure.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A illustrates a perspective view of a fastening clip assembly including a fastening clip and an insert.

FIG. 1B illustrates a profile side view of the fastening clip assembly of FIG. 1A.

FIG. 2 illustrates a section view of a fastening clip.

FIG. 3 illustrates an enlarged section view of the fastening clip of FIG. 2.

FIG. 4 illustrates an enlarged side view of a fastening clip inserted into a hole of a component.

FIG. 5 illustrates a perspective view showing an end of a fastening clip.

FIG. 6A illustrates a section view of a fastening clip assembly, schematically illustrating the insertion of an insert into a fastening clip in a first configuration.

FIG. 6B illustrates a section view of a fastening clip assembly, schematically illustrating the insertion of an insert into a fastening clip in a second configuration.

FIG. 6C illustrates a section view of a fastening clip assembly, schematically illustrating the insertion of an insert into a fastening clip in a third configuration.

FIG. 6D illustrates a section view of a fastening clip assembly, schematically illustrating the insertion of an insert into a fastening clip in a fourth configuration.

FIG. 7 illustrates an enlarged section view of a fastening clip assembly.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

In accordance with the present disclosure there is provided a fastening clip for mounting in a hole of a component according to the appended claims.

According to an aspect, there is provided a fastening clip for mounting in a hole of a component, the fastening clip comprising: a clip body having a first end, a second end and a pair of side walls extending from the first end to the second end and defining an internal cavity of the clip body, each side wall being provided with a window; a pair of retaining portions extending from the side walls at the second end of the clip body, each of the retaining portions comprising: a protruding portion that protrudes through the window in the respective side wall and is deflectable into the internal cavity of the clip body when the fastening clip is mounted through the hole of the component, and an end portion provided within the internal cavity of the clip body and extending towards the first end; and a head portion provided at the first end of the clip body and protruding from said side walls, the head portion comprising an opening; wherein each of the pair of side walls comprises a protuberance protruding into the internal cavity, and wherein the protuberance maintains a separation between the end portion of the retaining portion and the side wall for insertion of a removal tool between the end portion of the retaining portion and the side wall to deflect the retaining portion inwards for removal of the fastening clip from the component.

Accordingly, the protuberance allows for easier and quicker disassembly of the fastening clip from the hole of the component because the removal tool can deflect the retaining portion.

In examples, a distance between the protuberance and the end portion is less than a distance between the side wall and the end portion.

In examples, the protuberance and the end portion of the retaining portion are configured to guide a removal tool therebetween.

In examples, the end portion extends towards the first end of the clip body substantially parallel to the side wall.

In examples, the end portion has a substantially U-shape.

The fastening clip may include a combination of any of the previously described features.

In various examples, the fastening clip may be used to fasten an airbag assembly to an attachment panel of a vehicle, as set out in the background section.

According to another aspect, there is provided a method of disassembling the fastening clip from a hole in a component, the method comprising: inserting a removal tool having a pair of spaced apart gripping elements in an insertion direction into the opening in the head portion of the fastening clip; extending the removal tool in the insertion direction within the internal cavity of the clip body towards the second end of the clip body such that the pair gripping elements of the removal tool are guided along the pair of side walls and received between the side walls and the end portions; actuating the removal tool to move the gripping elements towards one another, thereby guiding the end portions of the retaining portions towards one another and deflecting the protruding portions into the internal cavity of the clip body; and withdrawing the removal tool in a removal direction, opposite the insertion direction, to remove the fastening clip from the hole of the component.

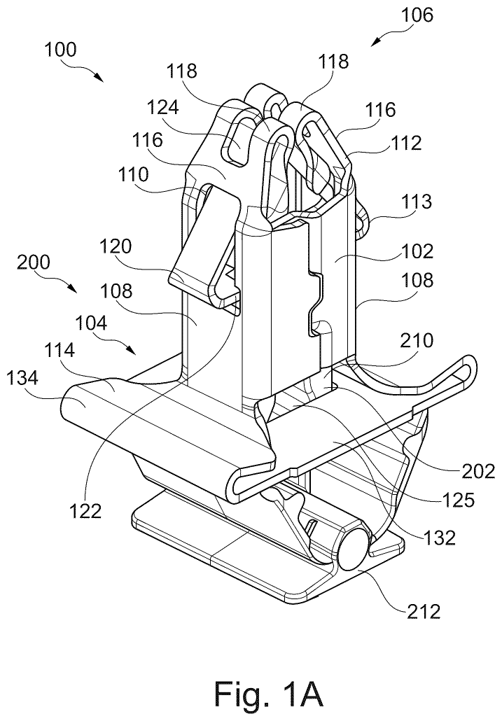

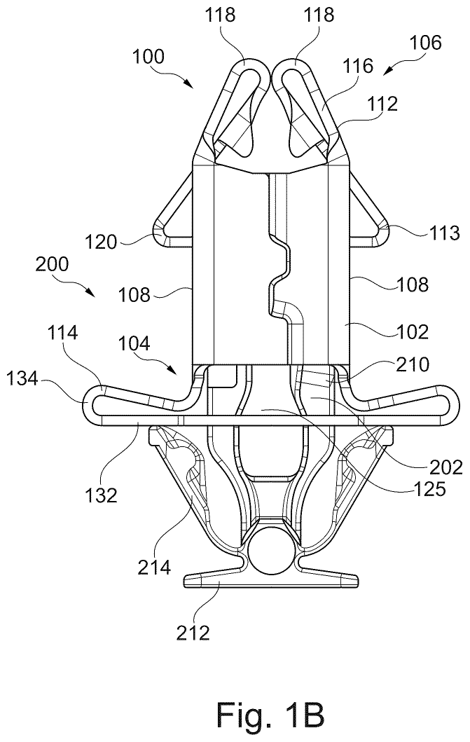

Referring now to FIG. 1A and FIG. 1B, there is shown a fastening clip 100. The fastening clip 100 includes a clip body 102 with a first end 104, a second end 106 and a pair of side walls 108 that extend between the first end 104 and the second end 106. The clip body 102 defines an internal cavity (126, FIG. 2). Each side wall 108 is provided with a window 110. The fastening clip 100 includes a pair of retaining portions 112 that extend from the respective side walls 108 at the second end 106 of the clip body 102. Each of the retaining portions 112 includes a protruding portion 113 that protrudes through the window 110 of the respective side wall 108. In this example, the pair of side walls 108 do not have any slots or apertures extending from the window 110 towards the first end 104 of the clip body 102.

The protruding portion 113 includes a first section 116 that is joined to the side wall 108, and further includes an intermediate bend 120, and a second section 122 that extends from the intermediate bend 120 through the window 110 in the internal cavity (126, FIG. 2) of the clip body 102. The second section 122 is substantially perpendicular to the side wall 108. The protruding portion 113 has a constant cross-sectional shape in a direction from the first bend 118 to the intermediate bend 120. This means that there is no slot or aperture in the protruding portion 113. The retaining portion 112 includes a slot 124 at the first bend 118. The slots 124 may be sized so as to limit, and define, the elastic resilience of the retaining portions 112.

The first end 104 of the clip body 102 is provided with a head portion 114 that protrudes from the side walls 108. In particular, the head portion 114 extends outward from both side walls 108 in a direction perpendicular to the plane of the side walls 108, and both sides of the head portion 114 each include a rounded edge 134 that joins together at an end section 132. The head portion 114 includes an opening 125, which in this example has a rectangular shape.

The fastening clip 100 is part of a fastening clip assembly 200 that includes an insert 202 that is inserted into the fastening clip 100 through the opening 125 in the head portion 114.

The insert 202 includes legs 210 that extend through the opening 125 of the fastening clip 100 and into the internal cavity 126 of the clip body 102. The insert 202 also includes arms 214 that bear against the surface of the head portion 114 when the insert 202 is inserted into the fastening clip 100. The arms 214 join together and terminate at a base 212.

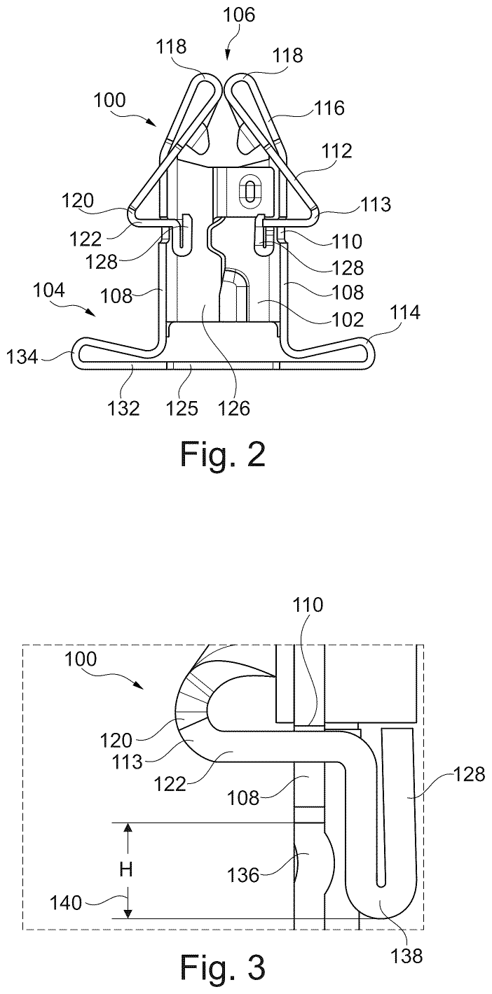

FIG. 2 and FIG. 3 show a section view of the fastening clip 100 that illustrates the retaining portions 112 and the protruding portions 113 of the retaining portions 112 more clearly. The protruding portions 113 protrude through the respective windows 110. More specifically, the second section 122 of each protruding portion 113 extends from the intermediate bend 120 through the window 110 into the internal cavity 126 of the clip body 102 and defines an end portion 128. The end portion 128 is substantially parallel to the side wall 108.

As best seen in FIG. 3, the end portion 128 is connected to the second section 122 by a second bend 138, which is a U-shaped bend. The side walls 108 in this example includes a protuberance 136 that protrudes inwards into the internal cavity 126. The protuberances 136 maintain a separation between the end portion 128 of the protruding portions 113 and the side walls 108 of the clip body 102. The end portion 128 of each of the protruding portions 113 extends within the internal cavity 126 of the clip body 102 towards the first end 104 of the clip body 102.

The end portion 128 has a height H that extends beyond the window 110. The height H of the end portion 128 may be a part of the end portion 128 that extends beyond the window 110 and which overlaps the side wall 108 of the clip body 102. The height H of the end portion 128 may be the distance from the second bend 138 to the furthest extent of the end portion 128. In this example, at least 40% of the height H of the end portion 128 extends beyond the window 110 and overlaps the side wall 108 of the clip body 102. However, it is envisaged that in other examples, this may be a different percentage, for example at least 50% or 60% of the height H of the end portion 128 extends beyond the window 110 and overlaps the side wall 108 of the clip body 102.

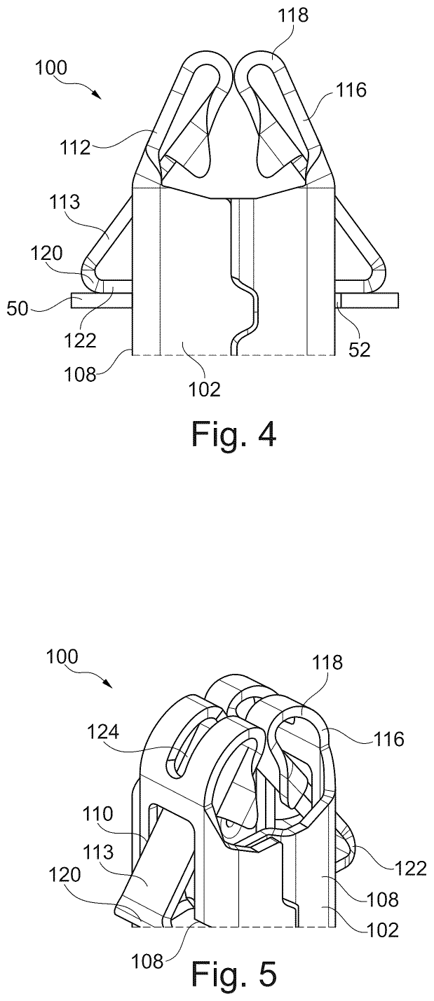

During use, the fastening clip 100 is inserted through a hole (52, FIG. 4) of a component (50, FIG. 4), which deflects the protruding portions 113 into the internal cavity 126 of the clip body 102. When the fastening clip 100 is inserted through the component 50, the protruding portions 113 spring outwards from the internal cavity 126 and through the respective windows 110 to their original position, preventing the fastening clip 100 from being removed from the component 50.

FIG. 4 shows a fastening clip 100 after being inserted through the component 50 and after the protruding portions 113 spring outward from the internal cavity 126 into their original position. A surface of the second section 122 of the protruding portion 113 is in engagement with the component 50. The protuberances 136 previously described with reference to FIG. 3 may be provided to maintain a separation between the end portion 128 of the retaining portion 112 and the side wall 108 of the clip body 102, so that a removal tool can be inserted between the end portion 128 and the side wall 108 to deflect the retaining portion 112 inwards for removal of the clip body fastening clip 100 from the component 50. The removal tool may be inserted through the opening 125 and may comprise a pair of long nosed pliers or specialist tool with opposing arms that are pushed between the end portions 128 and the side walls 108 to move the end portions 128 inwardly and therefore allow the fastening clip 100 to be removed from the component 50.

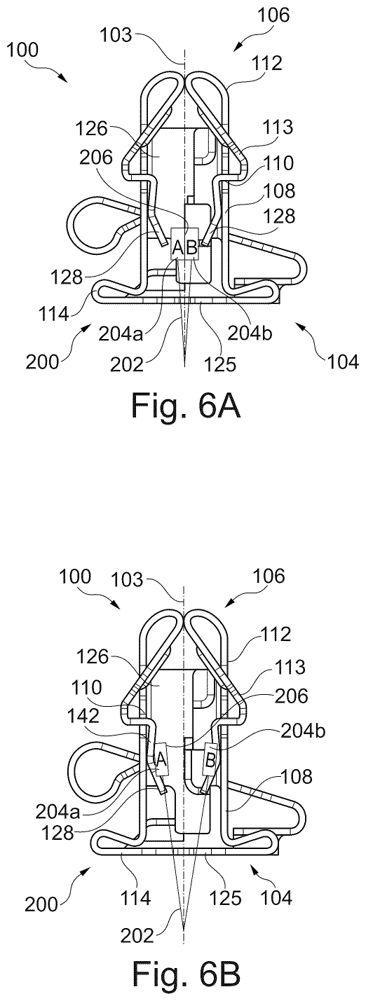

FIG. 5 shows an alternative arrangement of a fastening clip 100 in which the first section 116 that is joined to the side wall 108 has a rounded shape. The first bend 118 has a greater bending radius in comparison with the fastening clip 100 shown in FIG. 4.

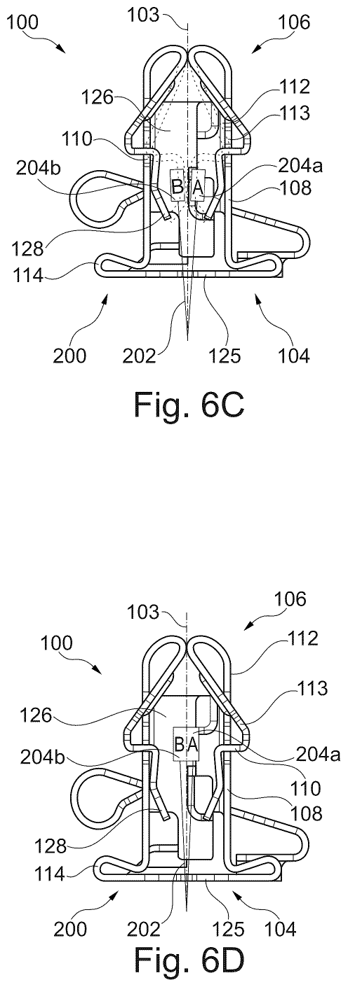

FIG. 6A shows a fastening clip assembly 200 illustrating an assembly verification process. The fastening clip assembly 200 includes a fastening clip 100 and an insert 202.

The insert 202 includes a pair of verification elements 204a,204b, which may be legs of the insert 202. The verification elements 204a,204b are retained within the internal cavity 126 of the clip body 102 by the side walls 108 in both a pre-assembled configuration and in an assembled configuration of the fastening clip 100 in the component 50.

As shown in FIG. 6A, the insert 202 and the verification elements 204a,204b are inserted into the internal cavity 126 of the fastening clip 100.

In the configuration shown in FIG. 6B, the verification elements 204a,204b open outward towards the side walls 108 and engage with a stopper 142 in the protruding portion 113. In this position the fastening clip 100 and insert 202 are in a pre-assembly configuration in which the fastening clip 100 and insert 202 can be pushed into a hole in a component.

FIG. 6C shows an arrangement in which the protruding portion 113 are deflected inwards into the internal cavity 126 as the fastening clip 100 is pushed into a hole in a component and the retaining portions 112 are deflected inwardly by engaging the hole. In this case, the verification elements 204a,204b are moved by the protruding portion 113 towards one another. In this example, the verification elements 204a,204b intersect one another.

As shown in FIG. 6D, the verification elements 204a,204b are in engagement (i.e. connection) with one another. This engagement may be via engaging elements 206 provided on one or both of the verification elements 204a,204b. Whilst the verification elements 204a,204b are in engagement, the retaining portions 112 return to their original position protruding through the windows 110 once the retaining portions 112 have passed through the hole in the component. The engagement of the verification elements 204a,204b allows the insert 202 to be inserted further into the internal cavity 126, and past the retaining portions 112 of the fastening clip 100. This provides verification that the fastening clip 100 is correctly mounted in the hole 52 of the component 50 without the insert 202 protruding through the clip body 102 or retaining portions 112. As such, no slots or apertures are required in the clip body 102 or retaining portions 112 for the insert 202 to extend through, increasing the pull-out resistance of the fastening clip 100.

The engagement via the one or more engaging elements 206 may be a frictional engagement and/or a locking engagement. The engaging elements 206 are provided to temporarily retain the pair of verification elements 204a,204b in engagement as the protruding portion 113 return to their original position protruding through the windows 110. The insert 202 can therefore be pushed further into the internal cavity 126 of the fastening clip 100. This provides verification that the fastening clip 100 is correctly mounted in the hole 52 of the component 50. When the engaging element 206 are in locking engagement, this locking may be temporary, reversible or permanent. The engaging elements 206 may include one or more of hooks, latches or adhesives, for example.

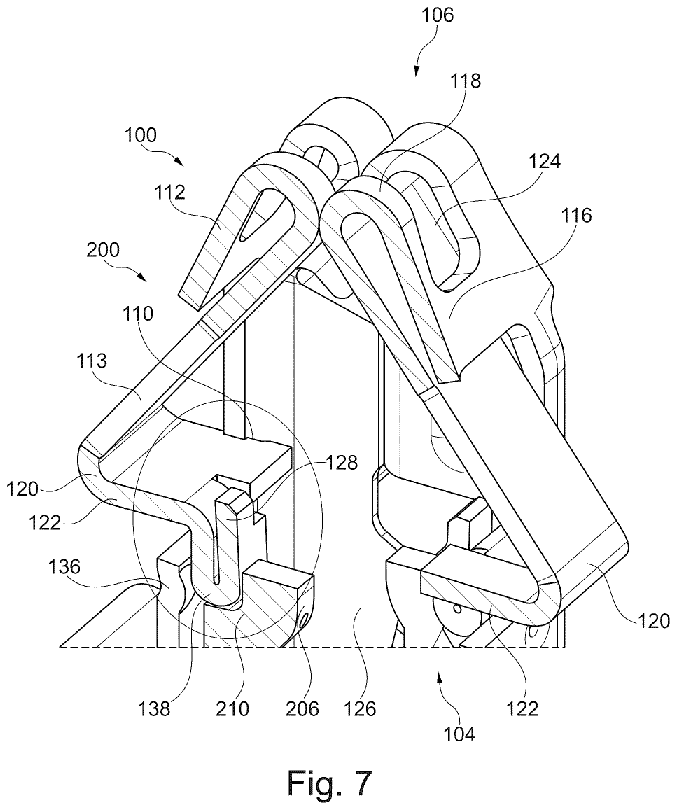

Although the fastening clip 100 in this example shown in FIG. 6A to FIG. 6D has spring legs at the defined by the second section 122, it is envisaged that the assembly verification process may be applicable for a fastening clip 100 that has end portions 128 in place of spring legs. FIG. 7 shows the legs 210 of the insert 202 engaging the end portion 128, in particular engaging the end portion 128 at the second bend 138.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A fastening clip for mounting in a hole of a component, the fastening clip comprising:
a clip body having a first end, a second end and a pair of side walls extending from the first end to the second end and defining an internal cavity of the clip body, each side wall being provided with a window;
a pair of retaining portions extending from the side walls at the second end of the clip body, each of the retaining portions comprising:
a protruding portion that protrudes through the window in the respective side wall and is deflectable into the internal cavity of the clip body when the fastening clip is mounted through the hole of the component, and
an end portion provided within the internal cavity of the clip body and extending towards the first end; and
a head portion provided at the first end of the clip body and protruding from said side walls, the head portion comprising an opening;
wherein each of the pair of side walls comprises a protuberance protruding into the internal cavity, and wherein the protuberance maintains a separation between the end portion of the retaining portion and the side wall for insertion of a removal tool between the end portion of the retaining portion and the side wall to deflect the retaining portion inwards for removal of the fastening clip from the component.

2. The fastening clip according to claim 1, wherein a distance between the protuberance and the end portion is less than a distance between the side wall and the end portion.

3. The fastening clip according to claim 1, wherein the protuberance and the end portion of the retaining portion are configured to guide a removal tool therebetween.

4. The fastening clip according to any one of claim 1, wherein the end portion extends towards the first end of the clip body substantially parallel to the side wall.

5. The fastening clip according to one of claim 1, wherein the end portion has a substantially U-shape.

6. A method of disassembling the fastening clip of claim 1 from a hole in a component, the method comprising:
inserting a removal tool having a pair of spaced apart gripping elements in an insertion direction into the opening in the head portion of the fastening clip;
extending the removal tool in the insertion direction within the internal cavity of the clip body towards the second end of the clip body such that the pair gripping elements of the removal tool are guided along the pair of side walls and received between the side walls and the end portions;
actuating the removal tool to move the pair of spaced apart gripping elements toward one another, thereby guiding the end portions of the retaining portions towards one another and deflecting the protruding portions into the internal cavity of the clip body; and
withdrawing the removal tool in a removal direction, opposite the insertion direction, to remove the fastening clip from the hole of the component.
